(19) United States
(12) Patent Application Publication
(10) Pub. No.: US 2002/0019839 A1
(43) Pub. Date: Feb. 14, 2002

(54) Apparatus and method of providing multilingual content in an online environment

(76) Inventor: P. K. Shiu, Boston, MA (US)

Correspondence Address: Sheldon R. Meyer, FLIESLER, DUBB, MEYER & LOVEJOY LLP, Suite 400, Four Embarcadero Center, San Francisco, CA, 94111-4156, US

(21) Appl. No.: 09/888,308

(22) Filed: Jun. 22, 2001

Related U.S. Application Data
(60) Provisional application No. 60/213,754, filed on Jun. 23, 2000.

(51) Int. Cl. G06F 17/00

(52) U.S. Cl. 707/536

(57) ABSTRACT

An apparatus and method of providing multilingual content in an online environment is presented. An embodiment of the invention may be employed in a web application development system which incorporates a template technology using simple server pages as the core of the development platform and allows a web application to be quickly made available in different languages.

### CLAIM OF PRIORITY

This application claims priority from provisional application “APPARATUS AND METHOD OF PROVIDING MULTILINGUAL CONTENT IN AN ONLINE ENVIRONMENT”, application Ser. No. 60/213,754, filed Jun. 23, 2000, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to apparatus and methods of providing multilingual content in an online environment, and specifically to an apparatus and method of automatically generating, by means of templates, web pages customized so as to be presented in a users chosen language.

### BACKGROUND OF THE INVENTION

In an online environment, such as the World Wide Web, it is often the case that a content provider Web page may be accessed by a user whose chosen first language is not that of the content provider. This poses a problem, in that the content provider typically wishes to present the most up-to-date information, and yet translation into another language typically takes a significant amount of time.

Traditional methods of tackling this problem usually require a developer, in cooperation with a (human) language translator, and perhaps also a Web site designer, to perform the translation and manually create the new page in the chosen language. Alternative methods can translate pages on the fly, often at the expense of consistent page design and layout.

### SUMMARY OF THE INVENTION

Accordingly, the invention seeks to reduce the burden of the traditional apparatus and method by providing an apparatus and methods of providing multilingual content in an online environment. Specifically, the invention provides an apparatus and method of automatically generating web pages, by means of templates, which are customized so as to be presented in a user's chosen language. The original language Web page is embedded with a set of tags. These tags allow the Web page to act as a template, in that each tag operates as a pointer to extract information from a dictionary in real-time, such as text, charts, diagrams, figures, data and other information, and display it along with the web page. The dictionary used, and hence the language the end user sees, is preferably chosen by the user or the user's application prior to visiting the site. In this manner, a Web page may be redesigned without regard to the actual content to be displayed; while the actual content can be modified (in the real-time dictionary) as required, without regard to its placement on the screen.

An embodiment of the invention may be employed in a web application development system which incorporates a template technology using simple server pages (SSP) as the core of the development platform. SSP allows an application to be quickly made available in different languages.

### Template Technology

Employing template technology in web application development allows a software application programmer to separate the visual design of the screen layout (or web page, such as may be displayed in a web browser) from the underlying logic of the software application. Typically, the look of a display screen changes more often than the logic of the software. Since software programmers often do not make good visual designers, it would seem reasonable to move the screen design aspect out of the application development process, in order to allow the programmer concentrate purely on the logic or functional aspects of the software.

In a typical web application, the look of the screen is largely controlled by the HTML code used to generate the screen. Template technology, such as is embodied in the invention, lets the programmer put most of the HTML code into a separate set of text files (the template files). At program execution (or run-time) the SSP engine combines the SSP-embedded HTML code with data from the software application to create a dynamic real-time display screen.

### SSP Technology

The system was designed with a few specific goals:

Simplicity

By defining a template technology, the developer has essentially another language at his or her disposal. The template technology includes extra features in addition to those of regular HTML, and these features have their own language. There are several existing template technologies, like Microsoft's Active Server Pages, and Allaires' Cold Fusion. Each of these products introduces a new language, each of which is generally complicated. A primary goal of the present invention is to define a language that is simple to learn and use, so that software may be developed more quickly.

In exchange for this simplicity, SSP need not contain as many features as the afore-mentioned template technologies in order to be commercially useful. This is not as bad a tradeoff as it first seems. In traditional methods, only a small portion of the feature set is typically used. SSP uses most, if not all, features all of the time.

Real-time support for multiple languages

In one embodiment, SSP supports the development process in English, yet allows developers to produce output in multiple languages with minimal effort. By way of example, many English speaking developers do not know any foreign languages. Many customers or content-subscribers may, however, use Japanese or another language as their first language. A method is therefore desired to enable the developers to write their software and generate screens primarily in English for their own use (i.e. development and testing), but also to easily generate screens in another language for the foreign language speaking users.

It is also desired to be able to adjust any language used in real time, such as to correct translations and grammar, with the system still running. To this end, the translated language text may be maintained by a web-based user interface as part of the development system. This allows a non-computer (i.e a human) translator to enter and edit any foreign text into the system.

Minimal data entry

Minimizing the necessary typing of data elements allows developers to generate screens in less time. Specifically, a typical template technology requires the developer to bind data items from the software application to corresponding display data items in the output screen. This binding usually involves creating the program to name each data item in the software application once, and to name it again in the template file. The use of SSP technologies eliminates this double typing.

### DESCRIPTION OF THE FIGURES

FIG. 1 shows a schematic illustration of an embodiment of a system of the invention for allowing a web page to be presented in multiple languages.

FIG. 2 shows a flow chart for a method in accordance with one embodiment of the present invention.

### DETAILED DESCRIPTION OF THE PREFERRED EMBODIMENT

The invention described herein relates to a development system and a method for creating multilingual content pages. It should be understood that the invention is not limited to the embodiments herein disclosed. Numerous details are set forth in order to provide a thorough understanding of the present invention. It will be evident, however, to one skilled in the art that the specific details need not be employed to practice the present invention.

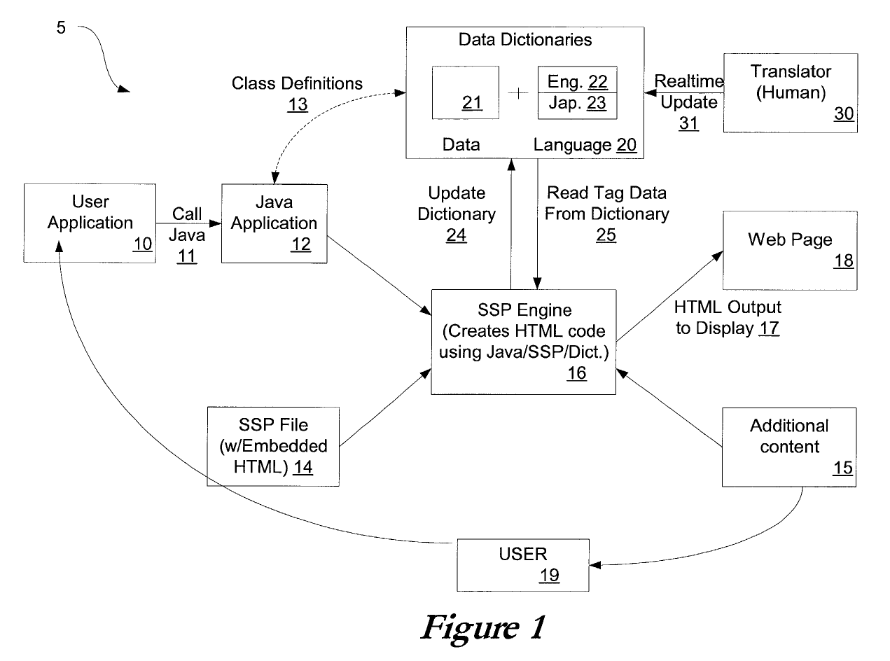

FIG. 1 shows an overview of an embodiment of the application development process, illustrating how the various components work interoperately to provide a language-specific page to an end user. An SSP engine operates upon the application and SSP file to dynamically extract information from the language dictionaries and display the information in real-time on a web page.

In this embodiment of the invention 5, a user requests web page content in a chosen language. The system automatically recognizes the language choice and generates the appropriate content by reference to a language dictionary.

As shown in FIG. 1, a user 19 operates a user application 10. At some point prior to operating the application, perhaps during an installation or configuration process, the user application is set to request content in a specific target language. From that point onward, until the target language is changed, the user application will request content in that language. In one embodiment, the user application 10 calls a Java application 12 via a Java call or subroutine 11. In some embodiments the Java application 12 may act alone as the user application on which the user operates. The Java application contains class definitions 13 in one or more databases 20 or directories, the significance of which are discussed below. The Java application further contains calls to the SSP engine server process.

An SSP file 14 is typically prepared prior to the user accessing the system. The SSP file contains both SSP-specific commands and standard HTML code. As such, it serves to call SSP data and to provide a visual layout for the resultant page 18.

The SSP engine 16 accepts both the input from the Java application 12 and the SSP file 14. Additional information may be combined at this point from other sources 15, which may be external to the system itself, such as third-party content providers. In this manner, the SSP engine 16 acts as a runtime compiler to extract necessary information from the constituent programs/files, and produce an output, which in one embodiment may be HTML code 17 output to the displayed web page 18. The entire process is referred to herein as ‘expansion’.

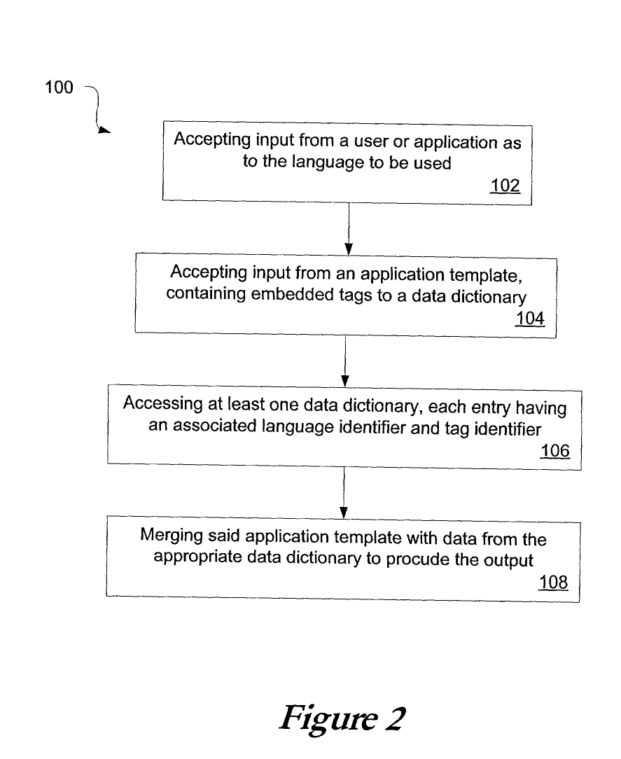

FIG. 2 shows a similar process 100, wherein input is accepted from a user or application 102 as to the language to be used. Input is then accepted from an application template 104, containing embedded tags to a data dictionary. At least one data dictionary is then accessed 106, wherein each entry has an associated language identifier and tag identifier. The application template is then merged with data from the appropriate data dictionary 108 to produce the desired output.

A novel feature of the invention is the use of embedded codes to identify and extract information or data content from a set of databases or dictionaries 20. The dictionary set 20 may contain a dictionary for each target language 22, 23. It may also contain dictionaries which are not specific to any particular language 21. Such dictionaries may for example contain data content (e.g., in numeric format) that would be recognizable in any of the target languages.

Because the user application is already pre-set to a specific target language, the system knows which of the language dictionaries 22, 23 it should use for output. When the SSP engine thus compiles the SSP file, it inserts 25 into the variable locations (e.g., content macro) the appropriate information from the appropriate language dictionary.

In a particular embodiment of the invention, the SSP engine may use information (e.g., as obtained from a user application) to update the content of one or more language dictionaries 24. The dictionaries may also be updated by external means. In one embodiment, a human translator 30 performs the translation on the text or content needed by the system. This translation may be done in real-time on the system itself, or could be done in an off-line manner at another location. The new translated information may then be uploaded directly to the appropriate language dictionary 31. Since the SSP engine 16 always responds to a user application by dynamically compiling the SSP file with the most current information from the dictionary, the new translated information appears in real-time. There is no need to redevelop a web page containing the information since the overall design of the web page (as defined by the SSP file) stays the same— the modified content is automatically inserted or expanded by the system prior to sending it to a user system for display.

### The SSP Process

Using the SSP Engine involves the following steps:

I. Creating an SSP file to define the output. This file contains HTML and SSP directives specifying one or more macros for expansion. This step may be accomplished by the programmer him/herself, or by another person— an SSP writer, who need not necessarily have the same skill set as the application programmer. (Code Example 2).

II. In a Java program, one or more Java objects or data variables are made available to the SSP engine by creating macro maps and adding the maps to the engine. (Code Example 1).

III. In the same Java program, the at.ssp.Server method is called to produce output from the named SSP file on expansion. (Code Example 1).

Code Example 1 show below is a simple example of a Java program used to call the at.ssp.Server process:

CODE EXAMPLE 1

```
Void someFunction ()
{
    at.ssp.Server server = new at.ssp.Server ();
    Language lang = new Language ();
    // set language to Japanese
    lang.httpEnc = “s-sjis”;
    lang.javaEnc = “SJIS”;
    // set the output language
    server.setLanguage (lang);
    // Create macro maps
    Map m1 = new Map (“var1”, “String One”);
    Map m2 = new Map (“var2”, 123);
    // This is some complex object
    MyClass c = new MyClass ();
    Map m3 = new Map (“fred”, c);
    // Add all these maps to the SSP engine:
    server.addMap (m1);
    server.addMap (m2);
    server.addMap (m3);
    // Now create output
    java.io.OutputStreamWriter writer = new
    java.io.OutputStreamWriter (System.out);
server.serve (“sample.ssp”, writer);
}
```

The following Code Example 2 illustrates an example of an SSP file containing both standard HTML and SSP-specific codes:

CODE EXAMPLE 2

```
    {{%*Sample SSP file}}
    <HTML><HEAD></HEAD>
    <BODY>
    {{%*Title in any language}}
<H1>{{:Sample_SSP_Output}} </H1>
First variable has value {{var1}} <BR>
Second variable has value {{var2}} <BR>
Third variable has many fields, like {{fred.field1}} and {{fred.field2}}
</BODY></HTML>
```

The sample program shown in Code Example 2 will produce the following HTML output in English, if the object MyClass c has field values of “453.23” and “other string”:

CODE EXAMPLE 3

<HTML><HEAD></HEAD>
<BODY>
<H1>Sample SSP Output</H1>
First variable has value String One <BR>
Second variable has value 123 <BR>
Third variable has many fields, like 453.23 and other
string.

Automatic Class Field Extraction

A programmer can pass a complex Java object to the SSP engine with a single call. The programmer does not have to pass and name each individual data field. For example, in the system there is a complex Account object, part of it is shown below in Code Example 4:

CODE EXAMPLE 4

```
Public class Account {
    Public String accountNbr ;
    Public String shortName
    Public SmartDate creationDate;
    Public SmartDate updateDate;
    ..etc..
    }
```

The programmer can then pass an Account object to the SSP system by simply passing the object as one unit (as illustrated in Code Example 5):

CODE EXAMPLE 5

Account acct = new Account ();
acct.load () ; // load data from database
Map m = new Map (“account“, acct);
server.addMap (m);
// instead of passing fields one by one:
map m = new Map (“accountNumber“, acct.accountNbr);
server.addMap (m);
map m = new Map (“createDateYear“, acct.creationDate.year);
server.addMap (m);
map m = new Map (“createDateMonth“, acct.creationDate.month);
server.addMap (m);
...etc...

The programmer or SSP writer can decide which fields to use in the output display at a later stage without having to change the original source program, since all of the fields in the Account object are available. Specifically, any data field or sub field that has public scope may be available for use.

Automatic SmartDate field Extraction

In the Code Example 4 shown above, the SSP engine understood the system special field type SmartDate. In seeing a SmartDate data field, SSP automatically creates four named macros from the SmartDate value. If the SmartDate map is called “date”, the SSP engine will make available to the SSP text file four fields: date which is the date as a string, date.y is the year number, date.m is the month number, and dated is the day number.

Smart Object Expansion Implementation

The SSP engine internally uses the Java language reflection support to analyze any object passed to the SSP engine via the addMap interface and create macros for each data field encountered. This defers the decision of which data field is needed for output generation. All the data fields are available to the SSP engine.

On receiving a map for an object, the SSP engine recursively parses each data fields in that class, and creates a macro entry internally for each of the accessible data field, using the data field name as a suffix to the map name.

Automatic List Box Generation

Often a data field represents a value that is one of a possible set of values. For example a gender field can contain either of the values ‘male’ or ‘female’. A phone number type field can contain values for home phone, work phone, fax, cellular phone, etc. The SSP engine has built in support for this kind of data field. To use this type of data field, the developer must do the following:

I. Define a Java data class subclassed from the enumeration class Enum.

II. Define a database table and store in the table the set of possible values, in both English and Japanese. Each enumeration type requires a database table.

III. Once the Java class and supporting table are properly defined, the SSP writer can reference a data field of the enumeration data type like any other macros. The SSP engine locates the value defined by the data field and outputs the text string associated with the current language for the current data field value as a read only field.

IV. If the SSP writer wants to output an input/edit field, the SSP writer appends the “special” marker character to the end of the macro—an exclamation point. Seeing an exclamation point, the SSP engine will output a set of HTML that creates a drop down list box for that data field.

The following Code Example 6 is an example of how an enumerated field is used as a drop down list feature:

CODE EXAMPLE 6

{{%* Drop down list box sample: }}
<SELECT NANE=sample>
{{dropDownVarName!}}
</SELECT>

The SSP engine will include the “selected” indicator for the current value in the set of drop down values it displays.

Formatted Numeric Field Display

The SSP engine recognizes that when displaying floating point numbers, it is often desirable to format the output with a specific number of decimal places, etc. The SSP writer may add a format description string to the end of a macro expansion SSP directive by first appending the “special” exclamation point character to the end of the macro name (Code Example 7):

CODE EXAMPLE 7

{{%*Expand this number as a fixed two decimal placed number:
}}
{{taxAmount!,##0.00}}

Any format string that is valid DecimalFormat string for Java.text.DecimalFormat string will work.

### SSP Language Syntax

A simple server page contains web page output coded in HTML, and optionally SSP directives or commands. In one embodiment, all SSP directives start with a special character sequence that is not normal HTML syntax. In the examples shown below, all directives start with a double set of curly open brace characters, followed by a series of keywords and special symbols.

Comment Directive

The comment directive allows the SSP writer to insert comments into the SSP file. Comments are not sent as part of the output, therefore the writer can put any documentation in an SSP using the comment directives knowing that the end user will not see them.

{{%*Any text can make up the comment.}}

Macro Substitution

The macro directive substitutes the macro directive with the corresponding data item value given by the programming in the software program during run-time.

{{variable_name}}
or a field within a Java object: {{object.field_name}}
or

Conditional Directive

The conditional directive allows selective display of output based on whether or not a variable is defined.

{{%IF variable_name}}
...output will be displayed if the variable exists....
{{%ELSE}}
...output will be displayed if the variable does not exist....
{{%ENDIF optional_closing_comment_txt}}

Include Directive

The include directive allows one SSP file to pull in the content of another SSP file. This directive allows the SSP writer to put commonly used output into a shared file.

{{%INCLUDE included_file_name optional_argument}}

The optional arguments are available in the included file as numbered variables {{1}}, {{2}} etc.

Looping Directive

The looping directive allows display of multiple instances of the same macro variable.

{{%LOOP variable_map_name}}
. . . this section will be display for each time the named
map
. ..is bound in the program. . .
{{%ENDLOOP optional_end_comment}}

Typed Expansion

The SSP engine understands the data type of the variable that it is expanding. Specifically it knows the following data types:

SmartDate

Enum

Checkbox

Double

It will be evident to one skilled in the art that other data types may be included and understood by the SSP engine, while still remaining within the scope and spirit of the invention.

### Multi-Lingual Support

Multi-Lingual Macros

A multi-lingual macro has the form:

{{:A_word_or_sentence}}

In this example the SSP writer has enclosed a single word (or words) in the SSP brackets with a leading colon character. If, on expansion during run-time, the output language is determined to be English, the SSP engine simply repeats the word or words with any underscored characters replaced with spaces. The SSP writer or developer can then see the output exactly as entered in English.

If the SSP engine encounters the macro for the first time, it also saves the macro into the SSP dictionary in the database. For identification purposes, the SSP engine may ignore case in the words.

If the output language is set to another language, the SSP engine locates this macro in the dictionary to determine whether there is a corresponding entry for that language. If such an entry exists, the translated text is output on expansion (and thereafter displayed) in place of the original English text.

Multi-Lingual Messages

Sometimes the multi-lingual macro facility is not enough to support text of longer sentences. For longer text sentences or entire paragraphs it is not practical to use the colon-styled way of entering the English original text. For these sentence types, SSP supports Message classes.

The Message class defines a set of unique message number and corresponding symbolic names. In the SSP file, the SSP writer can specify a message by specifying the message symbolic name:

{{#message_name}}

Message Implementation

When the SSP engine encounters the message reference during the expansion process, it looks up the message number from a database table. If the message number is found, the English or translated text in the message table is output to the screen depending on the current language setting.

### Programming Interface

A programmer may use the SSP Java language programming interface to invoke the SSP engine. In one embodiment, the main run-time interface is provided by the at.ssp.Server object. The setLanguage method set the run-time language for the next SSP processing. The clear, addMap, and removeMap methods provide the interface to bind, or assign, values to SSP macros. The serve method generates screen output from a specified SSP file by processing the SSP file and expand any macros defined in the file with any variables bound before using the addMap method.

A translate method provides direct access to the translation of a string to the current language setting. This method allows the Java program to use the language dictionary without having to use the SSP engine.

Translation Facilities Interface

The application server includes three specific internal functions for language translators to manage the multi-lingual support. A first function allows the translator to add or edit dictionary text associated with the basic dictionary. The translator can search or list all the words and phrases in the dictionary. After locating a dictionary entry the translator can edit the English or the translated text using the web browser interface.

A second function allows the translator to edit the set of data values associated with a enumerated data fields. In one embodiment the main screen allows the translator to select one of the enumerated data field sets. Once the set is selected, the translator can edit each individual possible data values in English or the translated text.

A third function allows the translator to edit the English or translated text corresponding to any particular defined message number.

Support Tools

Several support tools may be used with the invention. For example, a report tool may perform offline syntax checking on any SSP text file, optionally extracting the multi-lingual text defined in the SSP file.

Industrial Applicability:

Other features, aspects and objects of the invention can be obtained from a review of the figures and the claims.

It is to be understood that other embodiments of the invention can be developed and fall within the spirit and scope of the invention and claims. It will be obvious to one skilled in the art that the specific details described herein need not be employed to practice the present invention.

What is claimed is:

1. A system for generating multilingual pages, comprising:
a user application, capable of specifying a language to be used in the production of an output;
an application template, comprising a plurality of embedded tags;
at least one dictionary with a plurality of entries, wherein each said entry of said at least one dictionary is connectively associated with said user application and said application template; and
a processing module, capable of accepting input from said user application and said application template, and combining said input with data from the appropriate said dictionary to produce the content of said output.

2. A system according to claim 1, wherein each said entry of said at least one dictionary is connectively associated with said user application and said application template through common language specification and tag identifiers.

3. A system according to claim 1 wherein said data is selected from the group consisting of text, charts, diagrams, and figures.

4. A system according to claim 1 wherein a user of said user application is allowed to specify said language to be used in said output.

5. A system according to claim 1 wherein said user application automatically specifies said language to be used in said output.

6. A system according to claim 1 wherein said application template is constructed using Simple Server Pages.

7. A system according to claim 1 additionally comprising design information separate from said content of said output.

8. A system according to claim 7 additionally comprising a software engine adapted to combine said content and said design information to create a dynamic real-time display screen.

9. A system according to claim 1 wherein said output comprises HTML code.

10. A system according to claim 1, additionally comprising a set of template files adapted to store at least a portion of said output.

11. A system according to claim 1, wherein said data comprises translated language text.

12. A system according to claim 11 additionally comprising a web-based user interface adapted to maintain said translated language text.

13. A system according to claim 11 additionally comprising a translator adapted to edit said translated language text.

14. A system according to claim 1, wherein said user application comprises a Java application.

15. A system according to claim 14, wherein said Java application contains class definitions in at least one database.

16. A system according to claim 1, additionally comprising at least one source of external content.

17. A system according to claim 16, wherein said processing module is further adapted to accept input from said source of external content to be used in producing said content of said output.

18. A system according to claim 1 additionally comprising at least one macro for expansion.

19. A system according to claim 1 additionally comprising at least one support tool.

20. A method of generating multilingual pages in an online environment, comprising:
accepting input from a user application as to a language to be used to produce an output;
accepting input from an application template, the input containing embedded tags to a data dictionary;
accessing at least one data dictionary with a plurality of entries, wherein at least some of the entries have an associated language identifier and tag identifier; and,
merging said application template with data from the appropriate said data dictionary to produce said output.

21. A method according to claim 20 additionally comprising the step of allowing a user of said user application to select said language to be used in said output.

22. A method according to claim 20 additionally comprising the step of constructing said application template using Simple Server Pages.

23. A method according to claim 20 additionally comprising the step of maintaining design information separate from said content.

24. A method according to claim 20 additionally comprising the step of storing at least a portion of said output in a set of template files.

25. A method according to claim 20 additionally comprising the step of storing translated language information in said at least one data dictionary.

26. A method according to claim 25 additionally comprising the step of maintaining said translated language text using a web-based user interface.

27. A method according to claim 25 additionally comprising the step of maintaining said translated language text using a translator.

28. A method according to claim 20 additionally comprising the step of accepting input from at least one source of external content to be used in producing said content of said output.

29. A method according to claim 25 additionally comprising the step of generating at least one macro for expansion.

30. A method according to claim 25 additionally comprising the step of accessing at least one support tool.

31. A method according to claim 20 used in an online environment.

32. A system according to claim 1 used in an online environment.

33. A system according to claim 1 wherein said output is at least one display page.

34. A method according to claim 20 wherein said output is at least one display page.

35. A system for generating multilingual pages, comprising:
a user application capable of specifying a language to be used in the production of an output;
an application template comprising a plurality of embedded tags;
at least one dictionary associated with the language and with a plurality of entries, wherein each said entry of said at least one dictionary is connectively associated with said application template; and
a processing module capable of accepting input from said user application and said application template, and combining said input with data from the appropriate said dictionary to produce the content of said output.

36. A method of generating multilingual pages, comprising:
accepting input from a user application as to a language to be used to produce an output;
accepting input from an application template, the input containing embedded tags to a data dictionary;
accessing at least one dictionary associated with the language and with a plurality of entries, wherein at least some of the entries have an associated tag identifier; and
merging said application template with data from the appropriate said data dictionary to produce said output.

37. A method according to claim 20 performed in real time.

38. A method according to claim 36 performed in real time.
